(19) United States
(12) Patent Application Publication
(10) Pub. No.: US 2018/0228295 A1
(43) Pub. Date: Aug. 16, 2018

(54) SEATING WITH HEATING SYSTEM

(71) Applicant: Sit & Heat B.V., Wijchen (NL)

(72) Inventors: Jorg Rijkschroeff, Nijmegen (NL); Paul Schurink, Heerde (NL)

(21) Appl. No.: 15/751,110

(22) PCT Filed: Aug. 7, 2015
(86) PCT No.: PCT/EP2015/068311

§ 371 Date: Feb. 7, 2018

(51) Int. Cl. A47C 7/74; A47C 1/12

(52) U.S. Cl. CPC A47C 7/748; H05B 3/40; H05B 2203/029; A47C 1/12

(57) ABSTRACT

A seat for stadiums and sport facilities, includes a seating unit made entirely or partially of a plastic or a composite material. The seating unit is provided with a seat heating system, which includes one or more heating elements embedded in the seating unit.

### TECHNICAL FIELD

The invention pertains to the technical field of seats, more specifically to the field of seats with heated systems. The seats are specifically intended for outdoor use.

### BACKGROUND

Stadiums, sport facilities and outdoor arenas for events are nowadays usually heated by use of radiators mounted in the roof of the construction. The latter implies a huge energy cost, as these systems lack efficiency and much of the produced heating is lost or ineffective. A way of solving the latter is to provide individual heated seating systems.

Typically, large outdoor venues have either bleachers or hard, plastic seats, neither of which are particularly comfortable, especially in cool or cold weather. Stadium seats typically include a seat or base member and a backrest member which is pivotally attached to the seat member to allow it to be folded against the seat member for convenience of portability and storage.

Various proposals have been made for heated seat designs for use in an outdoor stadium environment.

DE 299 01 704 describes a seat suitable for stadiums whereby underneath the seating unit a heating element is installed for heating the unit.

DE 19813559 describes a heated seat of fiberglass reinforced polyester comprising a sheet-like heating element comprised of carbon black graphite.

DE3818406 describes a heated stadium seat whereby the shell is provided with a heating mat.

U.S. Pat. No. 5,915,783 describes a heated seat for outdoor use, whereby a heater is inserted in the hollow of the seat cushion.

U.S. Pat. No. 7,438,356 describes a portable stadium seat whereby an electrical heating element is contained in the foam cushion of the seat and the backrest members of the seat. An external and rechargeable power source for operating the heating elements is provided.

However, none of these proposals have seen any significant commercial exploitation since each design suffers from one or more disadvantages. Specifically, the design is too expensive to install initially; the design is too expensive to operate; or the design is not rugged and durable enough to withstand prolonged exposure to the temperature and precipitation extremes encountered in an outdoor stadium environment.

A particular challenge in the field of heated seats is the provision of an uniform heating of the seat. Many of the designs thus far known suffer from uneven heating which causes the presence of so-called hotspots (spots which have an undesired high heating). This uneven heating of the seat should be avoided, as it is unpleasant for the user, may cause premature deterioration of the seat.

There remains a need in the art for an improved design of heated seats suitable for large outdoor venues such as sport stadiums.

The present invention aims to resolve at least some of the problems mentioned above.

The invention thereto aims to provide a heated seating system which is easy in handling and low in production costs and which provides uniform seat heating. The heating system provides an efficient heat transfer to the person seated on the seat, thereby eliminating the need of external heating systems in the stadium. This will minimize the energy cost.

### SUMMARY OF THE INVENTION

The present invention provides for a seat with heating system, said seats are specifically suitable for outdoor use, e.g. in sport stadiums and the like. The seats provide for a more economical way of heating the stadiums, and serve as an alternative for the conventional heating systems. As each seat will provide a direct heating contact with the user through the seats of the current invention, a more economical and more efficient way of heating is provided. Moreover, the generated heat will provide a more pleasant experience for the user compared to the conventional heating systems.

In view of currently existing heated seats, the current invention provides for a low cost heated seat with easy design and easy manufacturing. The seats are durable, and easy in operation and provide a uniform heating of the seat (and back). Moreover, the installment of the seats was found to be less laborious and easier, even when compared to conventional non-heated seats.

In a first aspect, the current invention thereto provides for a seat according to claim 1 and an assembly of seats according to claim 23. A heating element according to the current invention is described in claim 18 and dependent claims. In a final aspect, the current invention provides for a method for manufacturing a heated seat according to claim 25.

### DESCRIPTION OF FIGURES

FIG. 1 shows a possible embodiment of a seat according to the current invention, mounted on a rail.

FIG. 2 shows a cross section of a rail provided with a seat according to an embodiment of the current invention, with detail of the electrical contacts within the rail.

FIG. 3 shows a possible embodiment of a heating element according to the current invention.

FIG. 4 shows a possible embodiment of a heating element according to the current invention.

FIG. 5 shows a detail of the electrode area of the heating element in FIG. 4.

FIG. 6 shows the results of an experiment whereby the contact force was measured for two different locations on the circumference of three different forms of electrodes.

### DETAILED DESCRIPTION OF THE INVENTION

The present invention concerns a seat which can be heated. The seat is particularly useful to be used in outdoor venues, such as stadiums and sport facilities. The invention may serve as an alternative for all the exterior heating units that are provided for heating in such venues. The system according to the current invention is easy in use and relatively cheap in production, and provides for an agreeable seating and reduction in the energy costs.

Unless otherwise defined, all terms used in disclosing the invention, including technical and scientific terms, have the meaning as commonly understood by one of ordinary skill in the art to which this invention belongs. By means of further guidance, term definitions are included to better appreciate the teaching of the present invention.

As used herein, the following terms have the following meanings:

“A”, “an”, and “the” as used herein refers to both singular and plural referents unless the context clearly dictates otherwise. By way of example, “a compartment” refers to one or more than one compartment.

“About” as used herein referring to a measurable value such as a parameter, an amount, a temporal duration, and the like, is meant to encompass variations of +/−20% or less, preferably +/−10% or less, more preferably +/−5% or less, even more preferably +/−1% or less, and still more preferably +/−0.1% or less of and from the specified value, in so far such variations are appropriate to perform in the disclosed invention. However, it is to be understood that the value to which the modifier “about” refers is itself also specifically disclosed.

“Comprise,” “comprising,” and “comprises” and “comprised of” as used herein are synonymous with “include”, “including”, “includes” or “contain”, “containing”, “contains” and are inclusive or open-ended terms that specifies the presence of what follows e.g. component and do not exclude or preclude the presence of additional, non-recited components, features, element, members, steps, known in the art or disclosed therein.

The recitation of numerical ranges by endpoints includes all numbers and fractions subsumed within that range, as well as the recited endpoints.

The expression “% by weight” (weight percent), here and throughout the description unless otherwise defined, refers to the relative weight of the respective component based on the overall weight of the formulation.

In a first aspect, the current invention provides for a seat, in particular for stadiums and sport facilities. The seat comprises a seating unit whereby said seating unit is made entirely or partially of a polymer such as a plastic or a composite material. The seating unit may comprise a seating part and a back part, optionally provided with arm supports. Said seating unit is provided with a seat heating system, whereby the heating unit comprises one or more heating elements. In a preferred embodiment, said heating elements are characterized in that said heating element(s) are at least partially embedded in or mounted to said seating unit.

The seating unit may be manufactured by all sorts of suitable polymers or plastics such as, but not limiting to polyvinylchloride, polyethylene, polypropylene, polystyrene, polyisocyanurate, polyurethane, nylon, aramide, polyester, bakelite, polymethylmethacrylate, polyethylene tereftalate glycol or any combination hereof. In a preferred embodiment, said seating unit is comprised of polypropylene.

For the purpose of the current invention, said composite material is to be defined as a material comprised of a combination of two or more materials which separately have different physical or chemical properties, but in combination produce a material with characteristics that differ from the separate components. In the end product (the composite material) the two or more materials will remain separate and distinct. For the purpose of the current invention said composite material may be chosen from the group of, but not limiting to fiber-reinforced materials such as polymers reinforced with glass fibers, carbon fibers, cellulose fibers; fiberglass; polyester resins, vinylester resins; epoxy resins and all materials known to a person skilled in the art which are suitable for this subject.

The seating unit may be mounted on a support structure. Said support structure may comprise out of various suitable materials, such as but not limiting to metal structure, concrete, wood, etc.

By providing a heating system embedded in or closely attached to the seating unit, a uniform heating of the seating unit may be achieved, providing a pleasant seat for the user, and thereby eliminating the need for external heating in the stadium. By preference, both the back and seating part of said seating unit is provided with heating elements. In another embodiment, only the seating part may be provided with 2-6 heating elements.

Said heating system will by preference be connected to an external power supply, such as a circuit track connected on its turn to a central power supply or a battery (either provided per seat or a central battery for a plurality of seats). Most preferably, said power supply is a fixed distribution system of electricity such as a circuit track connected to a central power supply.

In particular, when being embedded in the seat, heating elements of the current invention will be embedded in the polymer or composite material. Embedding will by preference occur during the manufacturing of the seating unit, e.g. during the moulding process.

In an embodiment of the current invention, said heating element comprises a conductive element or layer. With the term ‘conductive’, it is meant to indicate material that is able to conduct an electric current (electrical conductivity). Said layer or material is deemed conductive if it is found to have conductivity volume resistivity of 0.01 to 1 Ω·m or a conductivity of more than 0.5 S/m, preferably between 1 to 10 S/m (at 20° C.).

With the term ‘non-conductive’, it is meant to indicate material that is not able or only weakly able to conduct an electric current. Said material is deemed non-conductive if it is found to have a conductivity σ below 10⁻¹⁰ S/m or an electrical resistivity above 10¹² Ω·cm or 10¹⁰ Ω·m.

In a preferred embodiment, said conductive element or layer may comprise of a material chosen from the group of conductive carbon blacks, kanthal based alloys, nichrome based alloys, cupronickel, molybdenum silicide, silicon carbide, PTC ceramics or any combination thereof. In a more preferred embodiment, said layer or element comprises carbon black, including higher or lower structure carbon blacks, or the likes, e.g. acetylene black, channel black, furnace black, lamp black and thermal black. For the purpose of the current invention, said Carbon Black and likes is to be understood as the material resulting from combustion or charring of organic materials such as wood or bone or from petroleum products or vegetable oils.

In an embodiment, said heating element may take the form of a coiled coil element, a rod or rod-like element, a tube or tube-like element, a meander element or a resistance wire or a sheet or sheet like element. In a preferred embodiment, said element is a sheet or sheet like element.

Said conductive material such as carbon black will be dispersed in a polymer. By preference, said polymer is polypropylene. By preference, if Carbon Black is used, the used Carbon Black will have a particle size of below 1 micron, preferably between 0.01 and 1 micron, more preferably between 0.01 and 0.5 micron. In another embodiment, Carbon black is used as an aggregate, whereby said aggregate is comprised or Carbon Black particulates and one or more fillers, whereby fillers are present in said aggregate in an amount between 5 and 50%, more preferably between 10 to 25%. The particle size of said aggregate is preferably between 0.5 and 10 micron, more preferably between 0.5 and 5 micron, more preferably between 0.5 and 2 micron, such as around 1 micron. It was found by the inventors of the current invention that such particle size (either from Carbon Black alone or as aggregate) positively influences the uniform dispersion in the material and thus the uniform heating of the seating element according to the current invention.

By preference, said conductive material will be present in between 0.01 and 20%, more preferable between 0.1 and 15%, more preferably between 0.5 and 10%, in amount of weight of the polymer. The mixture of polymer and the conductive material (e.g. carbon black) will form the conductive layer or element.

Because of the well-defined conductivity range, the used conductive material such as the Carbon Black will act as an electrical heating element, thereby producing heat. Optionally, said seating unit will be provided with one or more conductors preferably installed or embedded at the lateral sides or underneath the seating unit. In a preferred embodiment, said conductive layer or element has an electrical resistivity of between 0.05 and 0.2 Ωm. The latter range allows optimal heat production in the seats, without overheating.

By preference, the density of the material will be between 0.5 and 2 g/cm³.

In a preferred embodiment, said heating element is comprised of at least two layers, a conductive layer as described above and a no-conductive layer.

In a preferred embodiment, said conductive layer is at least partially superimposed on the non-conductive layer and covers said.

Said non-conductive layer is by preference comprised of a polymer, preferably polypropylene.

Said conductive layer covers at least partially said non-conductive layer and whereby said conductive layer has an average thickness of between 1 and 3 mm, such as 2 mm. Said non-conductive layer has an average thickness of between 1 to 4 mm, more preferably between 2 and 4 mm, such as 3 mm.

In order to allow heating via electric current, one or more electrodes are provided to the heating element which allows connection to an electric circuit. In an embodiment, the element is provided with one pair of electrodes. In another, more preferred embodiment, two pairs of electrodes are provided. Preferably, the electrodes are present in one or more raised areas or platforms which are placed on top or arise from the conductive layer. In a preferred embodiment, said raised area or platform is comprised of conductive material, such as e.g. Carbon Black, embedded in a polymer. In a most preferred embodiment, said raised area or platform is made of the same material as the conductive layer. As such, the one or more electrodes are embedded in the conductive layer or element of said heating element.

The electrodes may be any sort of electrodes known in the art, such as copper or aluminum electrodes. In a preferred embodiment, said electrodes which are present in the conductive layer are aluminum electrodes. The inventors of the current invention surprisingly found that aluminum electrodes allow a uniform heating of the conductive layer and subsequently the seat, whereas other electrodes may tend to cause overheating around the electrodes and corrosion. Electrodes and cabling outside the conductive layer may be of any suitable type of material.

The electrodes may have any conventional form known in the art suitable for being used as electrodes. In a preferred embodiment, said electrodes have a rounded, oval or elliptical shape in cross-sectional view.

The inventors surprisingly found that the form of the electrodes contributes to the uniform heating of the seat. Although square or rectangular electrodes equally ensure a heated seat, the use of rounded, oval or elliptical shaped electrodes (in cross-sectional view) were found to decrease the occurrence of hot spots or overheating near the electrodes. Without being restrictive, it is believed that the rounded design of the electrodes provides a high and uniform contact force between the conductive layer and the electrode. The inventors found that a rounded electrode shows an overall better contact force.

Preferably, the contact pressure has to be as high as possible to avoid any gaps between the electrode and the compound. However, the residual stress induced in the compound must be lower than the acceptable value. In the current case, the inventors have found that a diameter of 2 to 5 mm of the electrode, e.g. 4 mm seems to be a good compromise. The contact pressure must be uniform to avoid higher local current density. The force value depends on the mesh size and should be used to calculate a contact pressure (force divided by the local mesh area).

In general, electrodes which provide an average contact force of between 15 and 40 N were found to be advantageous. More preferably, the contact force should be uniform around the circumference of the electrode, whereby the maximal difference of contact force between two points should not be more than 10 N.

In a more preferred embodiment, said electrode has a tubular or L-shaped form. Although other forms are shown the work, it was found that the best uniformity of contact pressure is obtained by a circular electrode.

In a preferred embodiment, the heating elements are embedded in the seat by an injection molding process, such as multi-component injection molding (2K or 3K). By preference, at least one heating element is present, preferably in the seating part. More preferably, said heating element will be positioned at the bottom of the seating part, invisible for a potential user.

In another embodiment, at least two heating elements are present, e.g. one in the seating part and one in the back part of the seat.

By means of an actuator present on said seat or seating unit, the heating system may be activated and/or regulated. Via the actuator and the (micro-) electronic elements that are preferably present in the actuator, the seat may be put under a low voltage. By lowering or increasing said voltage, the exact temperature of the heating element can be regulated. The user of the seat will be able to arrange the exact temperature of the heating or opt for a specific position or level of heating (e.g. low, medium or high heating).

Said actuator may be embedded in the seat during the manufacturing process. By preference, the actuator will comprise a solid form actuator such as a button or a switch. In a preferred embodiment, said actuator will comprise a touch button. In a further embodiment, the latter will be preferably embedded in a flexible print circuit or flex circuit. For the purpose of the current invention, said flexible print circuit or flex circuit is to be understood as an electronic circuit mounted or printed on a flexible plastic substrate. Said flexible plastic substrate may comprise, but is not limited to a polyimide, a polyaryletherketone, polyester (PET), polyethylene napthalate (PEN), polyvinylchloride (PVC) Polyetherimide (PEI), fluoropolymers (FEP) or copolymers.

By preference, said actuator will be interlinked with a processing unit for steering the heating system.

In one embodiment, each seat will be provided with an actuator for activating the system and/or for further regulation of the heat system. In another embodiment, one or more central actuators will be provided for activating and/or regulating a plurality of seats.

Energy supply for activating the system may be provided by an external energy source such as a battery. In one embodiment, each seat may be provided by an external battery. Said battery may be rechargeable and/or replaceable. In another embodiment, a power supply may be provided for a collection of seats, e.g. for a row of seats. As generally seen in stadiums and for instance bioscopes, multiple seats may be arranged in a horizontal line, one next to another. For the purpose of the current invention, a row or assembly of seats may be provided, whereby each of the seats are installed or mounted on a circuit track. Said circuit track may be any conventional circuit track known in the art and suitable for this purpose. Said central actuator will serve a central activating and/or regulating tool of the heating systems of the seats mounted on said track. This allows central control of the system and may also prevent improper use of the heating system, e.g. by stadium goers etc.

By use of a circuit track, the installment of the seats becomes particularly easy and straightforward, especially compared to the way conventional seats are currently mounted. Nowadays, seats in e.g. stadiums are mounted one per one on the surface (e.g. concrete). Mounting elements need to be provided per seat. This is laborious and inefficient. By use of a rail for mounting the seats of the current invention, the seats can be easily mounted on the rail, by means of form-fitting elements

In particular, in the current invention, a rail suitable for receiving a seat according to the current invention will be mounted on the surface. Mounting of the rail can be done by conventional methods known in the art. In a subsequent step, the seats will be mounted on the rail. By preference, rail and seat will therefore be provided with form-fitting elements which, when combined, serve for a proper and fixed connection between rail and seat. In one embodiment, said rail will be provided with a groove or indentation to receive a seat, whereby the electrodes of the seat partially or entirely fits into the groove or indentation of said rail and forms a tight connection between the two.

As such, adequate connection of the seat to the rail is ensured as well as a correct position of the seat onto the rail. In particular, the rail will be provided with protruding contacts, which will equally connect to the seat when mounted upon the rail. By means of these contacts, the seat will be provided by a low electrical voltage.

In an embodiment, the contact may be provided by covering means, which cover the contacts on the rail. Such covering means ensure that the contacts are secured when not being used, that is, not being in contact with a seat. This guarantees the safety of the set-up. For instance, when a seat is removed from the rail (e.g. during uproar in a stadium, or because of a defect), the covering means will completely cover the contact. Said covering means may comprise a plate, a lid, a valve or any other suitable covering means known in the art. In a preferred embodiment, the covering means will automatically cover the contacts when not the latter are not in contact with a seat. The covering means can be mechanically or electrically operated.

In a further embodiment, each seat may be provided with one or more sensor systems. Said sensors will be able to measure and/or record specific parameters relating to the use of the seats and may be integrated in the seats. In a preferred embodiment, said sensor is integrated in a flexible print. One of the sensors integrated in the seats may be a pressure sensor for detecting a certain pressure, e.g. to check whether a seat is occupied or not. A processing unit in connection to the sensor will be programmed in such way that upon receiving a pre-defined minimal pressure or more, detected by said sensor, said heating system will be activated by the processing unit. Hence, by the sensor the heating system will be activated upon receiving a person on said seating unit. Furthermore, by use of the pressure sensor, statistics based on the degree of occupancy of the seats may be provided.

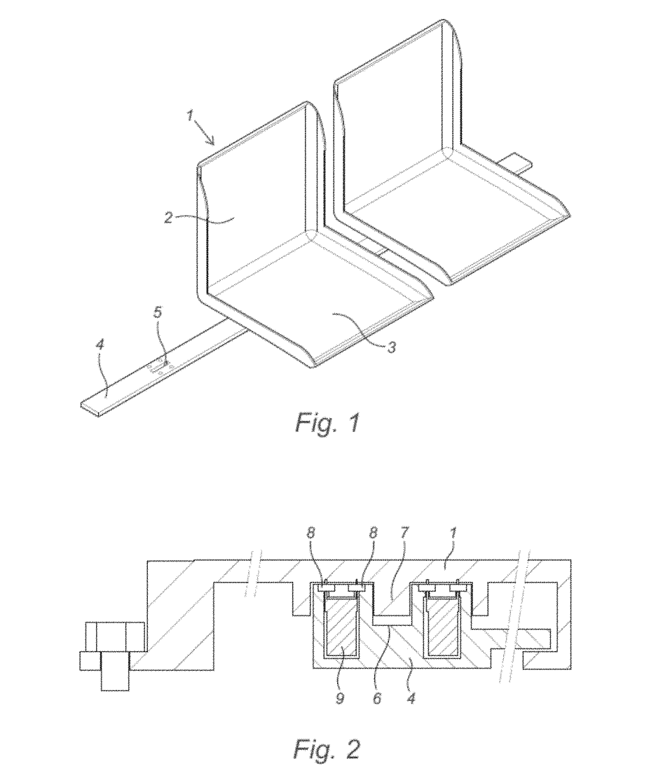

FIGS. 1 and 2 show details of an embodiment of seat and rails according to the current invention.

By preference, when a seat is no longer occupied, said heating system will, within a predefined time point, automatically cease to function. When no longer detecting the presence of an occupant, said sensor or sensor system of the processing unit will, after a predefined time point, provide a signal to the processing unit upon which that the heating system is turned off. The latter again ensures the safety of the system used.

Next to a heating system, said seat may also be provided with a cooling system, for cooling the temperature of the seats during hot weather days. Said cooling system may comprise one or more cooling elements, which are preferably embedded in or attached to said seating unit. For instance, cooling elements may comprise small ventilators may be embedded into the seating unit, which can equally be activated or regulated by an actuator present on said seat. Alternatively, cooling elements may comprise for instance a thermoelectric cooling element such as a Peltier element.

Said seats of the current invention may further be provided an RFID detection chip. Such chip may for instance serve as an anti-theft or a warning device. For instance, in the event that the seat is removed or defect, the RFID will provide a signal, warning the responsible that there is a potential problem with one of the seats. In a further embodiment, said seat may be provided with a socket for charging personal appliance such as cell phones, laptops, tablets, etc.

Additionally, the seat may be provided with visual appliances such as computer screens, LED, LCD, touch or other electronic screens for providing visual information to a user, or for allowing the user to communicate and/or interact with others, such as e.g. other seat users, people outside the stadium, people from catering, etc. The screens may further be used for providing information to the user, such as publicity or information on the event, etc. By preference, said visual appliance will be mounted or inserted on the back of said seat, so it is visible for the user sitting in the seat behind. Power supply occurs through the same rail system that provides power for the heating systems as mentioned above. Via the latter system, data transfer is equally made possible.

In another embodiment of the current invention, said heating element is not embedded in the seating unit, but attached to the outer surface of the seating unit by means for attaching. Said means of attaching are preferably chosen from the group of a foil or laminate. The heating element is connected to a power supply, which may be a power supply per seat, or connected to a circuit track on which said seat is mounted.

In a second aspect, the current invention provides for an assembly of seats, such as described above. Said assembly may comprise multiple numbers of seats, installed one next to another in a row mounted on a circuit track. Said number of seats per row or assembly will depend on the size of the venue. By preference, an actuator is provided for regulating the heating of the seats.

In an embodiment, the power per seat will be between 20 and 50 Watt, preferably 35 Watt whereby the voltage applied will lie between 40 and 60V, preferably 50V. In an embodiment, one assembly of seats may comprise 28 seats per row. In a stadium, divided in sections of 1000 seats, the maximal current of a section may be 800 A, whereby the maximal current per row of 28 seats is calculated to be 22.4 A.

In a third aspect, the current invention provides a method for the manufacturing of a heated seat such as described above. Said method comprises preferably a seating unit moulding step by making use of a mould. Said moulding of the seating unit may be achieved by injection moulding or extrusion moulding. The method according to the current invention further comprises a step of providing said heating elements to the mould during said moulding step.

A possible methodology for position, imbedding and connecting of the electrodes in the polymer to be heated according to the current invention is as follows. Electrodes are lengthened in order to allow protrusion in the back part. The distance between the electrodes is preferably kept the same or similar. These longer electrodes are preferably coated with carbon black in order to prevent exposure. Subsequently, the two loose electrodes at the end of the (preferably U-shaped) seat element is lengthened and are connected, thereby only requiring one electrical connection. Care should be taken to not over-mold the length in between the conductive material, as a current in the thina rea may occur and lead to excessive current density.

The electrodes in the back are subsequently moved towards each other, taken care however that the distance between the two is sufficient in order to prevent an elevation of current and/or temperature. In a preferred embodiment, the distance between the electrodes is preferably between 250 and 280 mm, more preferably between 260 and 265 mm.

The invention is further described by the following non-limiting examples which further illustrate the invention, and are not intended to, nor should they be interpreted to, limit the scope of the invention.

### FIGURES

FIG. 1 shows a possible embodiment of a seat according to the current invention, mounted on a rail which is suitable for actuating the heating system in the seat. The seat comprises of a seating unit 1 which has a back part 2 and a seating 3 part. The seating unit is provided with a heating system embedded in the material of the seating unit (invisible on FIG. 1). By preference, at least one heating element will be provided, embedded in the seating part 3 of the unit 1, invisible to a user.

The seating unit 1 is mounted with the seating part 2 on a rail 4. Mounting on the rail can be done by conventional methods. Said rail 4 is provided with form-fitting elements 5, in the current embodiment presented by a groove, for receiving the seat.

FIG. 2 shows a cross section of a rail provided seat according to an embodiment of the current invention, with detail of the electrical contacts within the rail. Both seating unit 1 and rail 4 are provided with form fitting elements 5. In the current invention, the form fitting elements provided to the rail comprise of an indentation or groove 6. Those present at the seating unit comprise of a protrusion 7. When combined, such as visible on the drawing, these form fitting elements serve for a proper and fixed connection between rail and seat.

The rail 4 is further provided by contacts 8, protruding from the rail in the direction of the seating unit. These contacts 8 are part of an inner circuit embedded in the rail. By means of the latter, the seating unit 1 can be placed under low voltage, thereby activating the heating elements present in the seating unit 1.

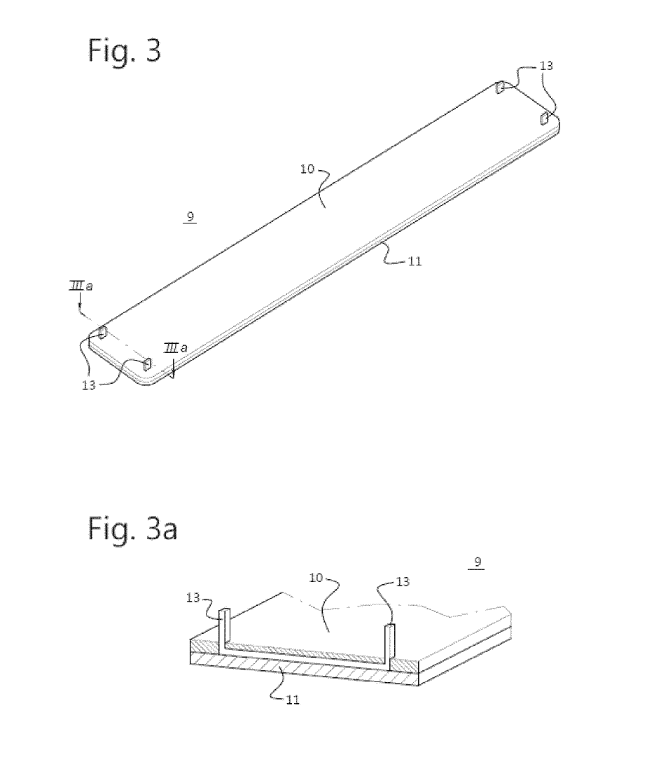

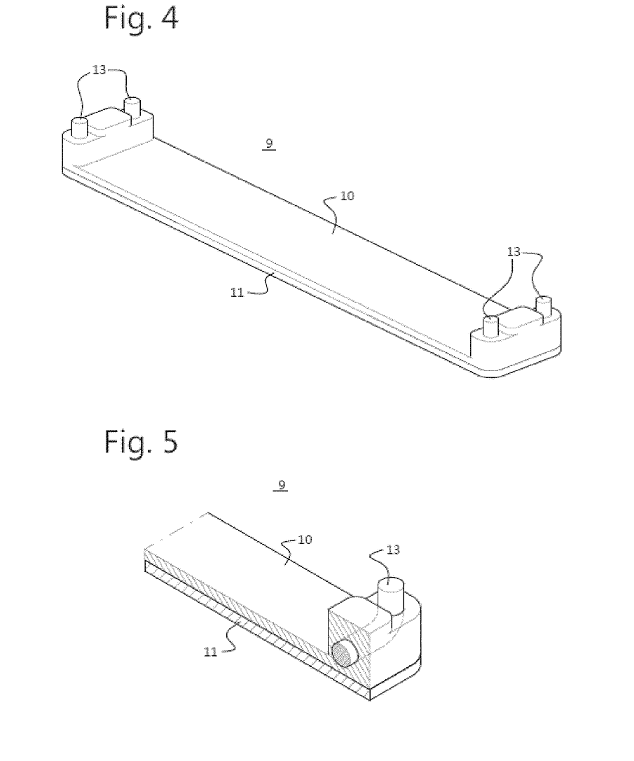

FIGS. 3 and 4 show a possible embodiment of a heating element 9 according to the current invention. FIG. 3 shows an embodiment according to the current invention, comprising a conductive layer 10 and a non-conductive layer 11. The conductive layer 10 completely covers said non-conductive layer which is preferably made of PP. The conductive layer 10 is comprised of PP with carbon black uniformly dispersed therein. Electrode pairs are provided at the edges of the element. The electrodes 13 shown in FIG. 3 have a rectangular shape. FIGS. 4 and 5 show an element with rounded, oval or elliptic electrodes (cross-sectional view). The electrodes can be made of copper or aluminum. Elements used in the current invention may have any kind of form and size, depending on the seats in which the latter will embedded. The embodiment shown in FIG. 3 has a rectangular size. Sizes may vary but possible dimensions are e.g. a length of 250 mm and a width of 40 mm. Both layers may have a similar thickness or vary in thickness. An overall preferred thickness of the layers ranges from 1 to 5 mm.

FIG. 4 shows a second possible embodiment according to the current invention. The heating element 9 is provided with a conductive layer 10 and a non-conductive layer 11. The conductive layer 10 covers the non-conductive layer 11. Raised areas 12 in the conductive layer 10 are provided at the edges of the element 9 which comprise electrodes 13 embedded therein. The electrodes 13 as shown in FIG. 4 have a rounded form in cross-section. The raised areas 12 are preferably made of the same conductive material as the conductive layer. The element 9 as shown in FIG. 4 has a rectangular form.

FIG. 5 is a detailed internal view of the electrode 13 and raised area 12 of the element 9 as shown in FIG. 4. As seen in FIG. 5, the element has a tubular, L-shaped form which extends in the raised area 12, horizontal to the conductive 10 and non-conductive layer 11.

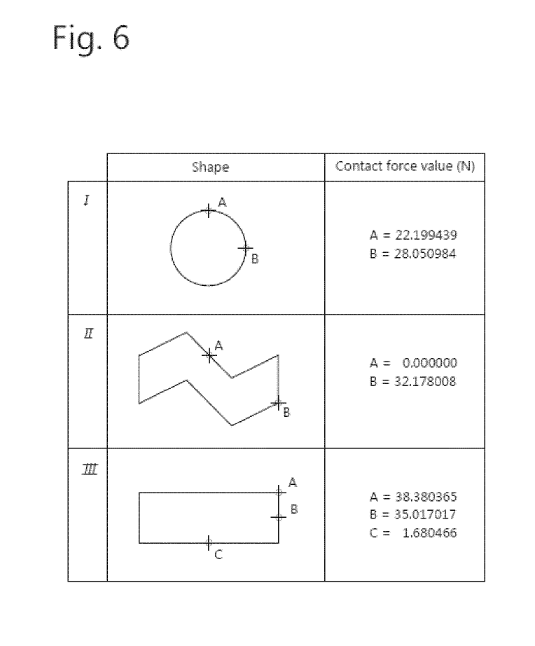

FIG. 6 shows the results of an experiment whereby the contact force was measured for two different locations on the circumference of three different forms of electrodes. From the results given in Newton, it is shown that the contact force on the rounded electrodes provide a more uniformly distributed contact force compared to the other two electrodes. The results obtained were confirmed with other electrodes such as oval or elliptic electrodes.

Table 1 shows the test results obtained by using a polymer seat (polypropylene) provided with a heating system according to the current invention (comprising 5 heating elements). The shells of the seat were brought to a starting temperature (initial temperature) and a voltage was applied in order to heat the seats. The final uniform temperature which lay around 40 to 42° C. was achieved within 30 minutes or less.

TABLE 1
Heating experiment of a seat

| | | Final | | | Time to final |
|---|---|---|---|---|---|
| Initial | Voltage | current | Power | Final | temperature |
| temperature | applied | calculated | (V × I) | temperature | (99%) |
| −10° C. | 60 V | 0.87 A | 52.2 W | 41.9° C. | 1830 s |
| | | | | | (30.5 min) |
| 0° C. | 54 V | 0.78 A | 42.1 W | 41° C. | 1725 s |
| | | | | | (28.75 min) |
| 10° C. | 47 V | 0.685 A | 32.2 W | 40.4° C. | 1615 s |
| | | | | | (27 min) |
| 29° C. | 30 V | 0.44 A | 13.2 W | 40.8° C. | 1365 s |
| | | | | | (22.75 min) |

1. A seat for stadiums and sport facilities, comprising a seating unit whereby said seating unit is made entirely or partially of a polymer or a composite material, said seating unit is provided with a seat heating system comprising one or more heating elements wherein the said heating element(s) are at least partially embedded in said seating unit or mounted thereon.

2. The seat according to claim 1, wherein the back and/or seating part of said seating unit is provided with one or more heating elements.

3. The seat according to claim 2, wherein the said heating element comprises a conductive element or layer.

4. The seat according to claim 3, wherein the said conductive element or layer is comprised of carbon black.

5. The seat according to claim 4, wherein the said carbon black is dispersed in a polymer, preferably polypropylene.

6. The seat according to claim 3, wherein the said conductive element or layer has an electrical resistivity of between 0.05 and 0.2 Ωm.

7. The seat according to claim 1, wherein the said heating element comprises a conductive layer and a non-conductive layer.

8. The seat according to claim 7, wherein the said non-conductive layer is a comprised of a polymer, preferably polypropylene.

9. The seat according to claim 1, wherein the said heating element comprising a conductive element or layer is provided with one or more electrodes, embedded in said conductive layer or element of said heating element.

10. The seat according to claim 9, wherein the said one or more electrodes have a rounded, oval or elliptical shape in cross-sectional view.

11. The seat according to claim 9, wherein the said electrode has a tubular or L-shaped form.

12. The seat according to claim 3, wherein the said conductive layer covers at least partially said non-conductive layer and whereby said conductive layer has an average thickness of between 1 and 3 mm.

13. The seat according to claim 7, wherein the said non-conductive layer has an average thickness of between 1 to 4 mm.

14. The seat according to claim 1, wherein the said heating elements are embedded into said seat by injection molding.

15. The seat according to claim 1, wherein the said seat is provided with an actuator for activating and/or regulating said heating system.

16. The seat according to claim 1, wherein the said seat is provided with one or more sensor systems.

17. The seat according to claim 16, wherein the one of said sensors will activate heating system upon receiving a person on said seating unit.

18. The heating element for a seat, wherein said heating element is comprised of a conductive layer or element and provided with one or more electrodes, embedded in said conductive layer or element of said heating element.

19. The heating element according to claim 18, wherein the said one or more electrodes have a rounded, oval or elliptical shape in cross-sectional view.

20. The heating element according to claim 19, wherein the said one or more electrodes have a tubular or L-shaped form.

21. The heating element according to claim 1, wherein the said heating element comprises a conductive and a non-conductive layer whereby said conductive layer covers at least partially said non-conductive layer and whereby said conductive layer has an average thickness of between 1 and 3 mm.

22. The heating element according to claim 21, wherein the said non-conductive layer has an average thickness of between 1 to 4 mm.

23. An assembly of seats according to claim 1, wherein the said seats are mounted on a circuit track.

24. The assembly of seats according to claim 23, wherein a central actuator is provided for regulating the heating of the seats.

25. A method for manufacturing of a heatable seat, comprised of a seating unit which is made entirely or partially of a polymer or composite material, comprising:
molding the polymer or composite material into a seating unit wherein one or more heating elements according to claim 18 are provided to the mold during said molding.
